(19) United States
(12) Patent Application Publication
(10) Pub. No.: US 2024/0216935 A1
(43) Pub. Date: Jul. 4, 2024

(54) FLUID PRODUCT DISPENSER

(71) Applicant: APTAR FRANCE SAS, Le Neubourg (FR)

(72) Inventors: Fabrice PERIGNON, La Chapelle Fortin (FR); Christophe TONDENIER, Belbeuf (FR)

(73) Assignee: APTAR FRANCE SAS, Le Neubourg (FR)

(21) Appl. No.: 18/289,081

(22) PCT Filed: May 9, 2022
(86) PCT No.: PCT/FR2022/050883

§ 371 Date: Oct. 31, 2023

(30) Foreign Application Priority Data
May 10, 2021 (FR) FR2104912

(51) Int. Cl. B05B 11/00; B65D 51/22

(52) U.S. Cl. CPC B05B 11/0054; B65D 51/222

(57) ABSTRACT

Fluid product dispenser having a fluid product reservoir with a neck defining an opening and an upper annular edge. The reservoir has a blocking member which seals the opening of the neck, the blocking member having a pierceable membrane, the pierceable membrane is disposed inside the neck axially away from the upper annular edge. The dispenser has an assembly having a dispensing member, such as a pump or a valve, received in the blocking member of the reservoir, the assembly having a piercing mechanism for piercing the pierceable membrane. The piercing mechanism has a piercing tip formed at the lower end of a sheath in which the dispensing member is received.

The present invention relates to a fluid product dispenser commonly used in the fields of perfumery, cosmetics or also pharmacy, to dispense various fluid products such as perfume, creams, lotions, etc.

In the prior art, dispensers are already known, the fluid product reservoir of which is presented in the form of a refill or of a cartridge, which is removably connected to an assembly comprising a dispensing member, such as a pump or a valve. Thus, the reservoir, once empty, may be replaced by a full reservoir. In order to enable a reservoir to be connected and disconnected, connection means of the snap-fastener or screw-fastener type are frequently used. This means that it must be possible to hold the reservoir firmly enough to unscrew it or to unsnap-fasten it. For this, it is necessary that at least one significant part of the reservoir remains accessible, and therefore visible, which can damage the overall appearance of the dispenser.

Document EP2916964 makes it possible to overcome this disadvantage with a removable connection system of the retractable tip pen-type, enabling the connection and the disconnection by quite simply pressing on the bottom of the reservoir. A first press followed by a release brings the reservoir into the sealed assembled position and another press followed by a release enables the reservoir to be ejected, so as to be able to then remove it completely. A cam system associated with a spring makes it possible to generate these successive operations by a single axial press on the reservoir.

The reservoir of the invention can be used as a refill in a dispenser of this type, but also as a non-replaceable reservoir.

In the prior art, it is known to seal the reservoirs in order to avoid any loss of fluid product and to protect its contents from the external environment. This is particularly the case for cosmetic products that degrade on contact with air. The sealing often consists of a flat lid that is glued, fixed or welded to the upper annular edge of the neck of the reservoir. This lid can be removed before mounting the reservoir in the assembly or can also be pierced by a piercing member of the assembly.

The disadvantage with piercing the lids is that the pump or valve is used to transmit the thrust force necessary to pierce the lid. However, this can lead to damage to the pump or the valve.

To solve this problem, the present invention proposes a fluid product dispenser comprising:
a fluid product reservoir comprising a neck defining an opening and an upper annular edge, the reservoir being provided with a blocking member which seals the opening of the neck, the blocking member comprising a pierceable membrane, the pierceable membrane is disposed inside the neck axially away from the upper annular edge, and
an assembly comprising a dispensing member, such as a pump or a valve, received in the blocking member of the reservoir, the assembly comprising piercing means for piercing the pierceable membrane,
characterized in that the piercing means forming a piercing tip at the lower end of a sheath in which the dispensing member is received.

Thus, it is possible to exert the thrust force directly on the sheath, which transmits it to the tip, and not on the pump or valve, which can remain without stress.

The pierceable membrane could be directly fixed in the neck, but preferably the blocking member comprises a sleeve that extends into the neck from the upper annular edge, the pierceable membrane then being connected to a lower end of the sleeve.

According to one advantageous embodiment, the neck can project from a shoulder, the pierceable membrane then being positioned substantially at this shoulder, with the sleeve extending substantially over the entire height of the neck.

Advantageously, the pierceable membrane may have a conical shape oriented towards the inside of the reservoir. It could also be plane, concave or convex.

In another aspect of the invention, the blocking member may comprise an annular collar that rests on the upper annular edge, the sleeve then being connected to the annular collar. The blocking member is preferably made as a single part of a flexible plastic material, such as an elastomer or a polyolefin.

According to an advantageous characteristic of the invention, the reservoir may further comprise a ring that is mounted around the neck and that comes into engagement with the annular collar to press it against the upper annular edge. The ring is preferably mounted fixedly and definitively on the neck.

Such a reservoir guarantees a minimal amount of air trapped in the reservoir and increased protection of the pierceable membrane. Its installation in and on the neck is easy, like a hollow stopper.

Advantageously, the sheath can come into sealed annular radial contact with the blocking member. The sealing between the reservoir and the assembly is thus ensured. The sleeve may form an annular sealing rib on its inner wall, the sheath then coming into sealed annular radial contact with this annular sealing rib. It could also be said that the annular collar internally forms an annular sealing rib on its inner wall, the sheath coming into sealed annular radial contact with this annular sealing rib.

In a practical embodiment, the sheath may be formed by a housing that includes reception means for receiving a connection system for the dispensing member and connecting the reservoir.

Preferably, the casing can comprise a case provided with an insertion/extraction opening and defining an insertion/extraction axis X, the fluid product reservoir being engaged in the case through the insertion/extraction opening and removably connected to the connection system, the reservoir comprising connection means and an accessible bottom at the insertion/extraction opening to exert an axial thrust on the reservoir, in order to cause the connection means to cooperate with the connection system. Preferably, the connection is removable by simply exerting a subsequent thrust on the bottom of the reservoir, which is then ejected. The removable connection can implement a cam track of the type used in pens with a retractable tip by axial pressing of a button.

The spirit of the invention resides in implementing a sheath provided with a tip for piercing the membrane without exerting any harmful stress on the dispensing member.

The invention will now be more fully described in reference to the accompanying drawings, giving as a non-limiting example, an embodiment of the invention.

In the figures:

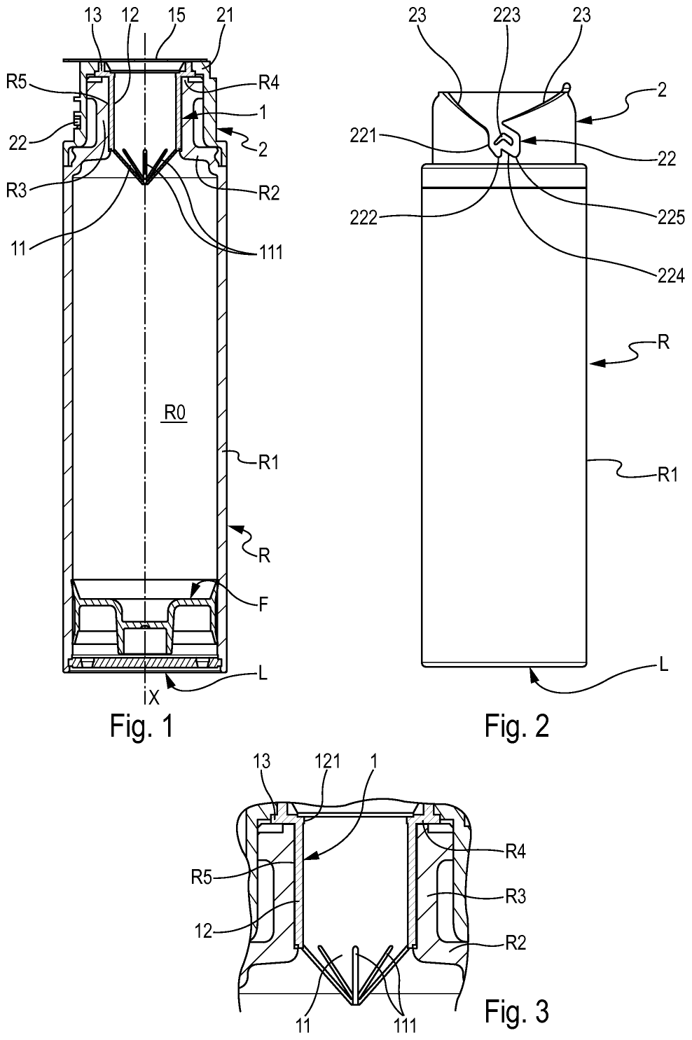

FIG. 1 is a vertical cross-sectional view through the reservoir of a fluid product dispenser according to the invention,

FIG. 2 is a front view of the reservoir of FIG. 1, FIG. 3 is an enlarged view of a detail of FIG. 1,

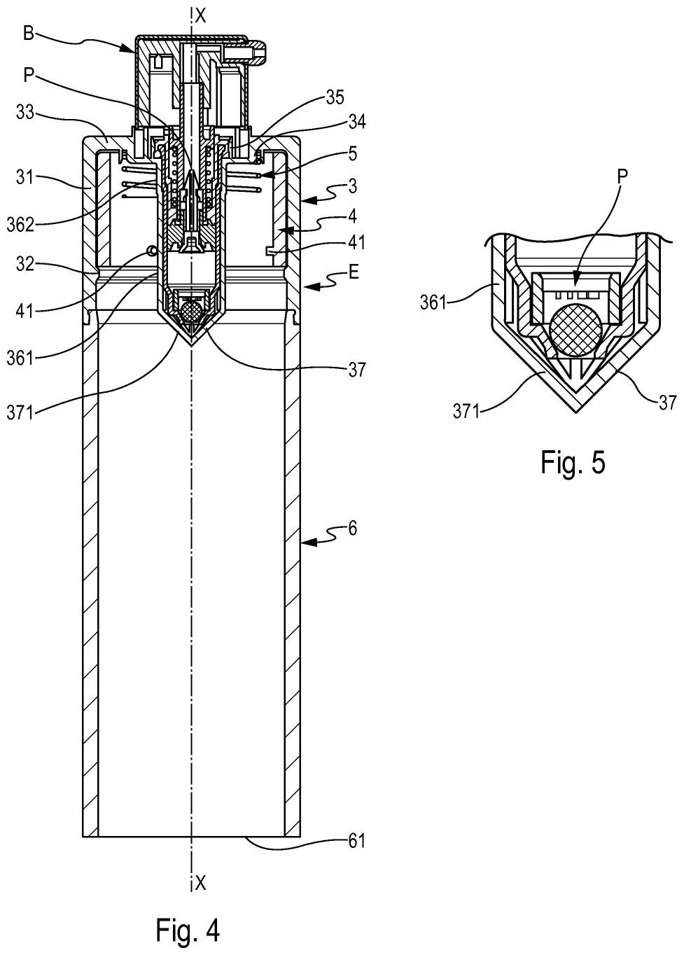

FIG. 4 is a vertical cross-sectional view through the assembly of a fluid product dispenser according to the invention, intended to be associated with the reservoir of FIG. 1,

FIG. 5 is an enlarged view of a detail of FIG. 4,

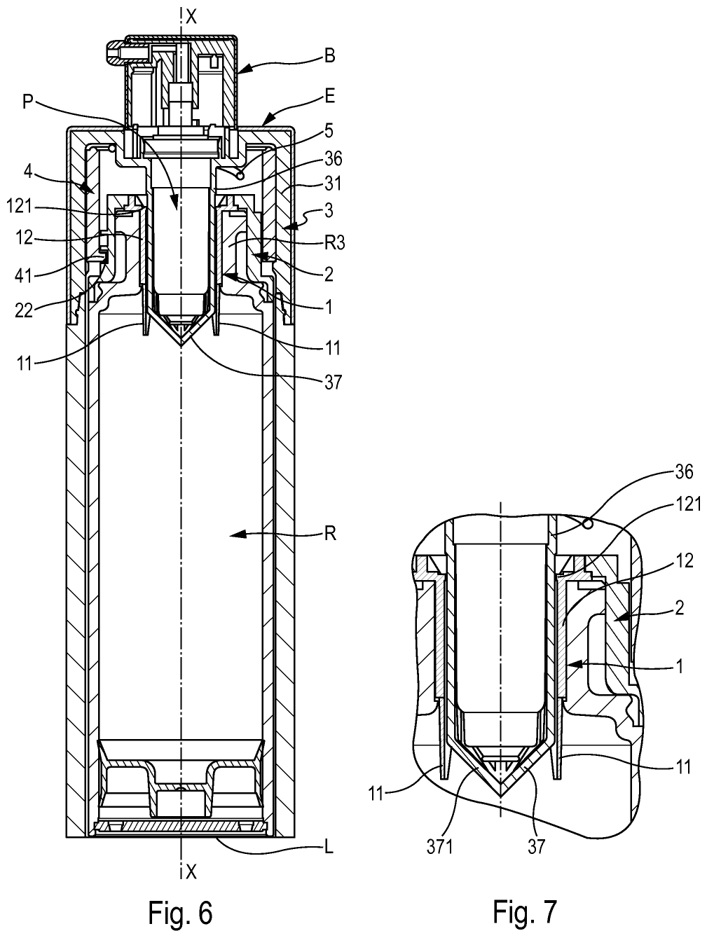

FIG. 6 is a vertical cross-sectional view through the fluid product dispenser resulting from the association of the reservoir and of the assembly according to the invention,

FIG. 7 is an enlarged view of a detail of FIG. 6,

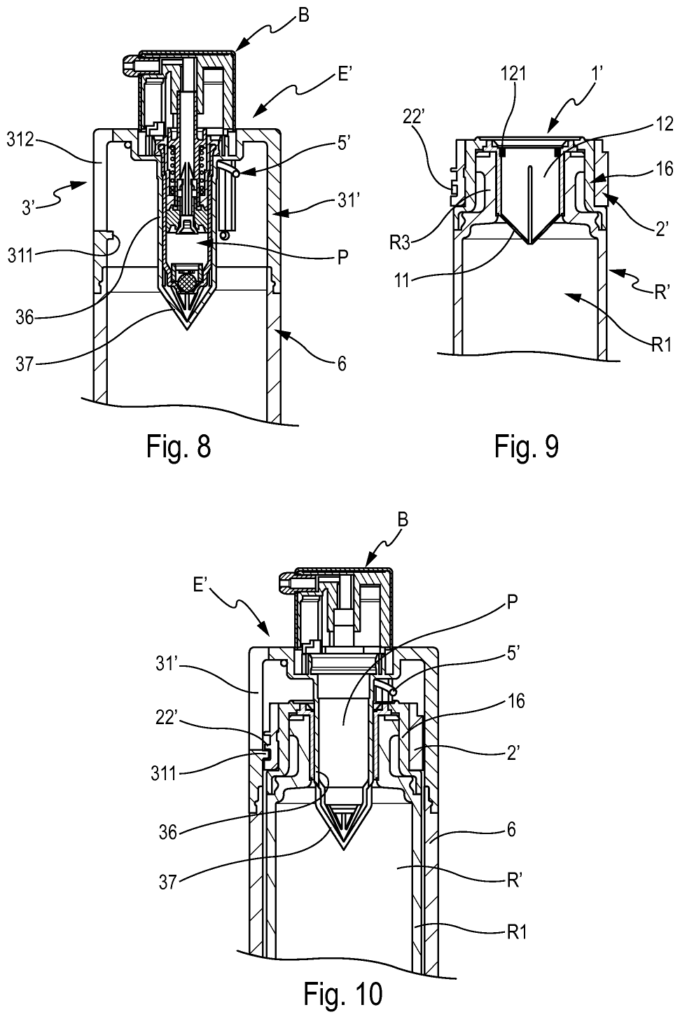

FIG. 8 is a view similar to that of FIG. 4 for a second embodiment of the invention,

FIG. 9 is a view similar to the view in FIG. 1, showing a second embodiment of the invention, and

FIG. 10 is a view similar to the view in FIG. 6 for a second embodiment of the invention.

The dispenser of the invention comprises an assembly E integrating a dispensing member P and a reservoir R containing a fluid product. The reservoir R is connected to the assembly E removably or definitively.

Now, reference will be made to FIGS. 1 to 3 to describe, in a detailed manner, the fluid product reservoir R. It comprises a container R0 intended to contain the fluid product, which can be a cream, a gel, a lotion, a serum, a perfume, etc. This container R0 comprises a cylindrical drum R1, wherein a follower piston F slides. Instead of the follower piston F, a flexible pocket can also be used. The lower end of the drum R1 is advantageously blocked by a bottom L. At its opposite end, the drum R1 is connected to a shoulder R2, which itself is extended by a neck R3 which projects upwards. This neck R3 forms an upper annular edge R4 and internally defines an opening R5, which makes the container R0 communicate with the outside. This is a conventional design for a fluid product reservoir.

According to the invention, the reservoir R is further provided with a blocking member 1 which sealingly seals the opening R5. This blocking member 1 comprises a pierceable membrane 11, which can be provided with tear lines 111 of a lesser thickness. This membrane 11 has, in this case, a conic shape with the tip oriented downwards, i.e. towards the follower piston F. The membrane 11 can have another shape, in particular flat. It can be noted that the membrane extends to the shoulder R2, to the lower end of the neck R3, and therefore axially away from the upper annular edge R4.

The blocking member 1 also comprises a sleeve 12 which can be cylindrical. This sleeve 12 extends over at least some of the height of the neck R3, and preferably almost over all of the height of the neck R3. The sleeve 12 can come into sealed contact with the internal wall of the neck R3 which defines the opening R5. The pierceable membrane 11 is connected to the sleeve at its lower annular edge. It can be noted that the sleeve 12 has a wall thickness greater than that of the pierceable membrane 11. It can be said that the sleeve 12 serves as a support for the membrane 11, so as to position it at the shoulder R2, so as to together constitute the roof of the container R0, opposite the follower piston F.

The blocking member 1 also comprises an annular collar 13 which rests on the upper annular edge R4. This collar 13 projects radially outwards from the upper end of the sleeve 12. It can be noted in FIG. 3 that an annular sealing ridge 121 is formed on the internal wall of the sleeve 12 at the collar 13. It can also be said that the collar 13 internally forms the annular sealing ridge 121. Its function is explained below. This ridge 121 could be located elsewhere over the height of the sleeve 12.

Optionally, the blocking member 1 can be provided with a lid 15 fixed on the collar 13 or on the upper end of the sleeve 12. This lid 15 is removable or pierceable.

This blocking member 1 makes it possible to seal the reservoir R inside the neck R3, such that there is no or practically no air in the reservoir. Indeed, the reservoir can be filled with fluid product around up to its shoulder R2 or a little below it. The blocking member 1 is then inserted into the neck R3 while letting air escape. Its pierceable membrane thus comes into the proximity of or even in contact with the fluid product, no longer leaving or only leaving a small amount of air in the reservoir R. In addition, thanks to its depressed positioning, the membrane 11 is protected against an accidental piercing.

The reservoir also comprises a ring 2, which is mounted on the neck R3 so as to surround it. The fixing of the ring 2 on the neck R3 can be done by any means, such as snap-fitting, forcibly mounting, screwing, bonding, welding, etc. The fixing can be removable or definitive. The ring can come into contact with the shoulder. The ring comprises a rest flange 21 which projects radially inwards. This flange 21 comes into contact with the collar 13 of the blocking member 1, so as to compress it on the upper annular edge R4 of the neck R3. It can be said that the ring 2 makes it possible to lock the blocking member 1 on the neck R3.

According to the invention, the ring 2 externally forms connection means intended to engage with the assembly E to connect the reservoir R to the assembly E. Advantageously, these are removable connection means, making it possible to remove the reservoir R from the assembly E. These connection means can comprise at least one cam track 22. In FIG. 3, it can be understood that there are three cam tracks 22 on the ring 2. Each cam track 22 comprises a locking housing 223, a first low abutment 222, a second low abutment 225 on either side of the locking housing 223, a first cam surface 221 and a second cam surface 224. The tracking of a lug through this cam track is as follows: first cam surface 221, first low abutment 222, locking housing 223, second cam surface 224, second low abutment 225, then the outlet of the cam track 22.

In order to bring the lug into a cam track from any angular orientation, the ring 2 advantageously forms ramps 23 which converge towards the cam tracks 22.

It must be noted that a reservoir with blocking member 1, but without cam track 22 can be considered, just like a reservoir with cam track 22, but without blocking member 1. Preferably, the reservoir R comprises both a blocking member and at least one cam track 22.

Now, reference will be made to FIGS. 4 and 5 to describe the assembly E in a detailed manner.

The dispensing member P of the assembly E can be a pump or a valve, which is provided with a pushbutton B to actuate it and thus dispense the fluid product. The dispensing member P is not critical for the invention and will therefore not be described in detail. When this is a pump, this conventionally comprises a pump body with a fluid product inlet. A piston sealingly slides into the pump body to pressurise a dose of fluid product. The piston is mounted on an actuation rod which is moved back and forth against a return spring. The dose of pressurised fluid product escapes through an outlet valve towards the pushbutton B which comprises a fluid product outlet. This design is absolutely conventional for a pump in the fields of cosmetics, perfumery or pharmacy.

The assembly E comprises a casing 3 forming an external shell 31, which is cylindrical. The shell 31 internally forms a retaining ridge 31 and at its upper end, an annular plate 33. A socket 4 is received between the retaining ridge 31 and the plate 33, so as to be axially blocked, while being rotatably free on itself. This rotary socket 4 forms at least one cam lug 41, and preferably three, on its inner wall. These cam lugs 41 are located in the proximity of the lower edge of the socket 4. The casing 3 also forms an anchoring profile 34 for a spring 5 which extends freely downwards inside the socket 4. The casing also comprises receiving means 35 for the dispensing member P.

Advantageously, the casing 3 further comprises a sheath 36 which extends freely downwards inside the shell 31, the socket 4 and the spring 5. This sheath 36 forms, at its lower end, a piercing tip 37, designed to pierce the membrane 11 of the reservoir R, as can be seen below. The tip 37 comprises at least one opening 371, which can be seen in FIG. 5, which communicates directly with the inlet of the dispensing member P. The tip 37 can have a conic shape. The sheath can form a lower section 361 of small diameter and an upper section 362 of greater diameter. The main part of the dispensing member P is housed in the sheath 36 and occupies almost all of the volume of the sheath. The external wall of the dispensing member P can optionally come into contact with the internal wall of the sheath 36.

The assembly E also comprises a case 6 which is connected to the lower end of the shell 31. The case 6 could be made of one piece with the shell 31. This case 6 defines an insertion/extraction opening 61 and an insertion/extraction axis X.

According to the invention, the reservoir R is connected to the assembly E as follows. The reservoir R is inserted into the case 6 through its opening 61 with the neck R3 at the top. The axial insertion is continued until the piercing tip 37 abuts against the pierceable membrane 11. The lid 15 has been previously removed or pierced by the tip 37. A sufficient axial pressure enables the tip 37 to break the membrane 11, preferably at its tear lines 111. The axial insertion can thus be continued until the cam lugs 41 come into contact with the ring 2. This axial insertion is done against the spring 5. In most cases, the lugs 41 will come into contact with the ramps 23. From this moment, an axial pressure on the reservoir R will rotate the socket 4 in the shell 31. The lugs 41 will slide over the ramps 23 to reach the inlets of the cam tracks 22. From there, each lug 41 will follow the following tracking. The lug 41 slides under the action of an axial thrust against the spring 5 on the first cam surface 221 which drives it to the first low abutment 222. A release of the axial pressure thus brings the lug 41 into the locking housing 223 under the action of the spring 5. The reservoir is thus connected to the assembly E. The sealing between the reservoir R and the casing 3 is ensured by the annular radial contact of the upper section 362 of the sheath against the sealing ridge 121 of the blocking member 1. The user can thus use the dispenser by actuating the pushbutton B using a finger. Fluid product coming from the reservoir R is thus dispensed by the dispensing member P.

When the reservoir R is empty, an axial pressure on the reservoir R extracts the lug 41 from the locking housing 123 and brings it to slide over the second cam surface 224 to the second low abutment 225. A release of the pressure thus brings the lug 41 to be released from the cam track 22 under the action of the spring 5. The reservoir R can thus be freely extracted from the case 6. Another reservoir R can thus be put in place in the assembly E in the manner described above.

It must be noted that the rotary socket 4 makes it possible to connect the reservoir R in the assembly E without rotating it, since it is the socket which rotates on itself. This provides a more pleasant feeling and completely conceals the operation of the connection.

It can also be noted that an assembly E with tip 37, but without connection system (socket 4 and spring 5), can be associated with a reservoir R with blocking member 1, but without cam track 22. Likewise, an assembly E with connection system (socket 4 and spring 5), but without tip 37, can be associated with a reservoir R with cam tracks 22, but without blocking member 1. In addition, an assembly E with connection system (socket 4 and spring 5), but without tip 37, can be associated with a reservoir R with cam tracks 22 and blocking member 1. And also, an assembly E with tip 37, but without connection system (socket 4 and spring 5), can be associated with a reservoir R with blocking member 1, but without cam track 22: the connection between the reservoir and the assembly thus being made by any known connection means, like for example snap-fitting, screwing, bayonet, etc.

By referring to FIGS. 8 to 10, a second embodiment of the invention is seen, which differs from the first, in that the cam tracks of this second embodiment are formed by a rotary member, while they are fixed in the first embodiment, where the lugs are formed by a rotary member, namely the rotary socket 4.

In FIG. 8, the assembly E′ comprises a casing 3′ having an external shell 31′ to which the case 6 is connected. The external shell 31′ internally forms three lugs 311, which are therefore fixed. Optionally, the shell 31′ comprises a side window 312. The sheath 36 with its tip 37 are made of one piece with the shell 31′. The assembly E′ also comprises a spring 5′.

In FIG. 9, the neck R3 of the reservoir R′ is surrounded by an external skirt 16, which is advantageously made of one piece with the sleeve 12 and the membrane 11 of the blocking member 1′. This external skirt 16 is therefore fixedly mounted on the neck R3. It is surrounded by a ring 2′, which is rotatably mounted on the skirt 16. The ring 2′ can therefore freely rotated on itself around the skirt 16, which is fixedly mounted around the neck R3. The rotary ring 2′ externally forms three cam tracks 22′, which are identical or similar to those of the first embodiment. The ring 2′ can also form ramps, identical or similar to the ramps 23.

In FIG. 10, the reservoir R′ is in place inside the assembly E′. The tip 37 has pierced the membrane 11 and the lugs 311 are engaged with the cam tracks 22′, in the same way as in the first embodiment. During the connection, the ring 2′ rotates around the skirt 16, such that the drum R1 can remain rotatably static.

This second embodiment therefore consists of moving the rotary element of the assembly E on the reservoir R′, while holding the lugs on the assembly and the cam tracks on the reservoir. Without moving away from the scope of the invention, it is also possible to form the lugs on the reservoir and the cam tracks on the assembly. Consequently, there are four possible embodiments:
Rotary lugs by formed the assembly (1st embodiment),
Rotary cam tracks formed by the reservoir (2nd embodiment),
Rotary lugs formed by the reservoir, and
Rotary cam tracks formed by the assembly.

1. A fluid product dispenser comprising:
a fluid product reservoir comprising a neck defining an opening and an upper annular edge, the reservoir being provided with a blocking member which seals the opening of the neck, the blocking member comprising a pierceable membrane, the pierceable membrane is disposed inside the neck axially away from the upper annular edge,
an assembly comprising a dispensing member, such as a pump or a valve, received in the blocking member of the reservoir, the assembly comprising piercing means for piercing the pierceable membrane,
wherein the piercing means comprise a piercing tip formed at the lower end of a sheath in which the dispensing member is received.

2. The fluid product dispenser according to claim 1, wherein the sheath comes into sealed annular radial contact with the blocking member.

3. The fluid product dispenser according to claim 1, wherein the blocking member comprises a sleeve which extends into the neck from the upper annular edge, the pierceable membrane being connected to a lower end of the sleeve.

4. The fluid product dispenser according to claim 3, wherein the neck projects from a shoulder, the pierceable membrane being positioned substantially at this shoulder, with the sleeve extending substantially over the entire height of the neck.

5. The fluid product dispenser according to claim 3, wherein the sleeve forms an annular sealing rib on its internal wall, the sheath coming into sealed annular radial contact with this annular sealing rib.

6. The fluid product dispenser according to claim 1, wherein the pierceable membrane has a conical shape facing the inside of the reservoir.

7. The fluid product dispenser according to claim 1, wherein the blocking member comprises an annular collar that rests on the upper annular edge, the sleeve being connected to the annular collar.

8. The fluid product dispenser according to claim 7, further comprising a ring mounted around the neck and which comes into engagement with the annular collar to press it against the upper annular edge.

9. The fluid product dispenser according to claim 7, wherein the annular collar internally forms an annular sealing rib on its internal wall, the sheath coming into sealed annular radial contact with this annular sealing rib.

10. The fluid product dispenser according to claim 1, wherein the sheath is formed by a housing that comprises receiving means for the dispensing member and a connection system for the reservoir.

11. The fluid product dispenser according to claim 10, wherein the casing is provided with a case provided with an insertion/extraction opening and defining an insertion/extraction axis X, the fluid product reservoir being engaged in the case through the insertion/extraction opening and removably connected to the connection system, the reservoir comprising connection means and a bottom accessible at the insertion/extraction opening to exert an axial thrust on the reservoir in order to cause the connection means to cooperate with the connection system.
